(19) United States
(12) Patent Application Publication
(10) Pub. No.: US 2021/0294442 A1
(43) Pub. Date: Sep. 23, 2021

(54) TOUCH SCREEN AND TOUCH DISPLAY DEVICE

(71) Applicant: SHENZHEN CHINA STAR OPTOELECTRONICS SEMICONDUCTOR DISPLAY TECHNOLOGY CO., LTD., Shenzhen (CN)

(72) Inventors: Chongming HU, Shenzhen (CN); Yuchun HSIAO, Shenzhen (CN); Guofu TANG, Shenzhen (CN); Mingjun ZHOU, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/626,532

(22) PCT Filed: Nov. 5, 2019
(86) PCT No.: PCT/CN2019/115665

§ 371 Date: Dec. 25, 2019

(30) Foreign Application Priority Data
Jul. 8, 2019 (CN) 201910609077.1

(51) Int. Cl. G06F 3/041; B32B 3/28; B32B 3/30; B32B 7/12

(52) U.S. Cl. CPC G06F 3/041; B32B 3/28; B32B 2457/208; B32B 7/12; B32B 3/30

(57) ABSTRACT

A touch screen and a touch display device are provided. Since a concave region of a cover is recessed into a chamber to form a recess portion, a space occupied by the chamber is reduced, thereby reducing a hollow feeling caused by the chamber and reducing a spatial instability of the chamber. In addition, a sealant prevents moisture, dust, and the like from entering the chamber.

### FIELD OF DISCLOSURE

The present disclosure relates to the field of display technologies, and in particular, to a touch screen and a touch display device.

### BACKGROUND

In a conventional touch display device, the touch display device includes a cover, a display panel, and a touch panel disposed between the cover and the display panel. The cover and the touch panel are connected by a sealant, and the cover, the touch panel, and the sealant are combined to form a chamber. Due to the chamber, the touch display device has a hollow feeling, and a space occupied by the chamber is unstable.

Accordingly, it is necessary to propose a technical solution to solve the problems of the hollow feeling and instability caused by the chamber of the touch display device.

### SUMMARY OF DISCLOSURE

An object of the present disclosure is to provide a touch screen and a touch display device to solve the problems of the hollow feeling and instability caused by the chamber of the touch display device.

A touch screen includes a touch panel, a cover, and a sealant. The cover includes a concave region and a connection region surrounding the concave region, the sealant is disposed in the connection region and is configured to connect the cover with the touch panel, and the sealant, the touch panel, and the cover form a chamber. The concave region of the cover is recessed into the chamber to form a recess portion. The chamber is a vacuum chamber, and a thickness of the sealant gradually increases from the concave region toward a direction away from the concave region.

In the above touch screen, the recess portion includes a concave surface near the touch panel.

In the above touch screen, a vertical distance from a top of the concave surface near the touch panel to the touch panel is greater than or equal to zero.

In the above touch screen, material of the sealant includes a hot melt adhesive.

A touch screen includes a touch panel, a cover, and a sealant. The cover includes a concave region and a connection region surrounding the concave region, the sealant is disposed in the connection region and is configured to connect the cover with the touch panel, the sealant, the touch panel, and the cover form a chamber, and the concave region of the cover is recessed into the chamber to form a recess portion.

In the above touch screen, the recess portion includes a concave surface near the touch panel.

In the above touch screen, a vertical distance from a top of the concave surface near the touch panel to the touch panel is greater than or equal to zero.

In the above touch screen, the chamber is a vacuum chamber.

In the above touch screen, a thickness of the sealant gradually increases from the concave region toward a direction away from the concave region.

In the above touch screen, material of the sealant includes a hot melt adhesive.

A touch display device includes a touch screen. The touch screen includes a touch panel, a cover, and a sealant. The cover includes a concave region and a connection region surrounding the concave region, the sealant is disposed in the connection region and is configured to connect the cover with the touch panel, the sealant, the touch panel, and the cover form a chamber, and the concave region of the cover is recessed into the chamber to form a recess portion.

In the above touch display device, the recess portion includes a concave surface near the touch panel.

In the above touch display device, a vertical distance from a top of the concave surface near the touch panel to the touch panel is greater than or equal to zero.

In the above touch display device, the chamber is a vacuum chamber.

In the above touch display device, a thickness of the sealant gradually increases from the concave region toward a direction away from the concave region.

In the above touch display device, material of the sealant includes a hot melt adhesive.

The present disclosure provides the touch screen and the touch display device. Since the concave region of the cover is recessed into the chamber to form a recess portion, a space occupied by the chamber is reduced, thereby reducing a hollow feeling caused by the chamber and reducing a spatial instability of the chamber. In addition, the sealant prevents moisture, dust, and the like from entering the chamber.

### BRIEF DESCRIPTION OF DRAWINGS

FIG. 1 is a schematic diagram of a touch screen of a first embodiment of the present disclosure.

FIG. 2 is a schematic diagram of a touch screen of a second embodiment of the present disclosure.

FIG. 3 is a schematic diagram of a touch screen of a third embodiment of the present disclosure.

FIG. 4 is a schematic diagram of a touch display device of the first embodiment of the present disclosure.

Reference numerals in the drawings are as follows: 100 touch screen; 200 touch display device; 10 touch panel; 11 cover; 11a concave region; 11b connection region; 11c concave surface; 111 recess; 100a chamber; 12 sealant; 13 display panel; 14 adhesive layer; A top

### DETAILED DESCRIPTION

With reference to the accompanying drawings, the technical solution of the embodiments of the present disclosure is described clearly and completely as following. Obviously, the given embodiments are only parts of the embodiments of the present disclosure, but not all embodiments of the present disclosure. Based on the embodiments of the present disclosure, all other embodiments which can be obtained without devoting a creative effort by those skilled in the art should be deemed to fall within the scope of the present disclosure.

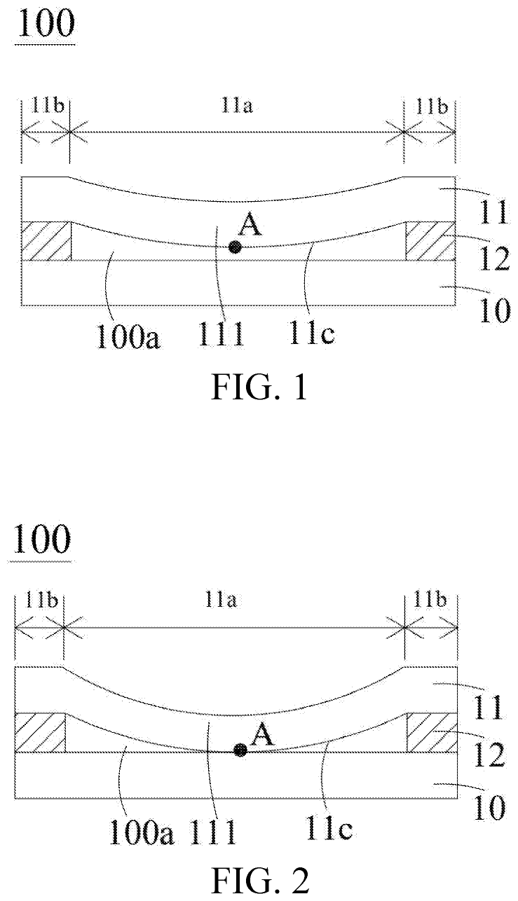

Please refer to FIG. 1, which is a schematic diagram of a touch screen of a first embodiment of the present disclosure. The touch screen 100 includes a touch panel 10, a cover 11, and a sealant 12.

The touch panel 10 is configured to convert a touch operation into an electrical signal. The touch panel 10 includes a substrate, a touch electrode disposed on the substrate, and a touch trace electrically connected to the touch electrode. The touch panel 10 is a flexible touch panel.

The cover 11 is configured to protect touch panel 10. The cover 11 is a transparent glass cover. The cover 11 includes a concave region 11a and a connection region 11b surrounding the concave region 11a. The cover 11 and touch panel 10 are oppositely arranged.

The sealant 12 is configured to adhere the cover 11 to the touch panel 10, and it also acts as a seal. The sealant 12 is disposed in the connection region 11b and is configured to connect the cover 11 with the touch panel 10. A shape of the sealant 12 is a rectangular ring, that is, a middle of the sealant 12 is hollow. Material of the sealant 12 includes a hot melt adhesive. A thickness of the sealant 12 ranges from 0.15 mm to 0.45 mm. The sealant 12 is configured to adhere the cover 11 to the touch panel 10 by placing the hot melt adhesive on the touch panel 10 and heating and melting it.

The sealant 12, the touch panel 10, and the cover 11 form a chamber 100a. The concave region 11a of the cover 11 is recessed into the chamber 100a to form a recess portion 111. The recess portion 111 of the cover 11 can be formed by applying an external force to the concave region 11a of the cover 11. The recess portion 111 includes a concave surface 11c near the touch panel 10. A vertical distance from a top A of the concave surface 11c near the touch panel 10 to the touch panel 10 is greater than zero. The concave region 11a of the cover 11 is recessed into the chamber 100a to form the recess portion 111. The concave region 111 occupies a partial space of the chamber 100a, which reduces the space of the chamber 100a, thereby improving a hollow feeling and reducing spatial instability of the chamber 100a.

Furthermore, the chamber 100a is a vacuum chamber. With the sealant 12, a sealing of the touch screen 100 is further improved, and moisture and dust are prevented from entering the chamber 100a, so that the cover 11 of the concave region 11a is closer to the touch panel 10. The chamber 100a takes up less space, thereby improving the hollow feeling and reducing the spatial instability of the chamber 100a.

Please refer to FIG. 2, which is a schematic diagram of a touch screen of a second embodiment of the present disclosure. The touch screen 100 shown in FIG. 2 is basically similar to the touch screen 100 shown in FIG. 1, and a difference is that a vertical distance from a top A of a concave surface 11c near a touch panel 10 to the touch panel 10 is zero. Thus, a space of a chamber 100a is further reduced, thereby reducing a hollow feeling and an instability of the space occupied by the chamber 100a.

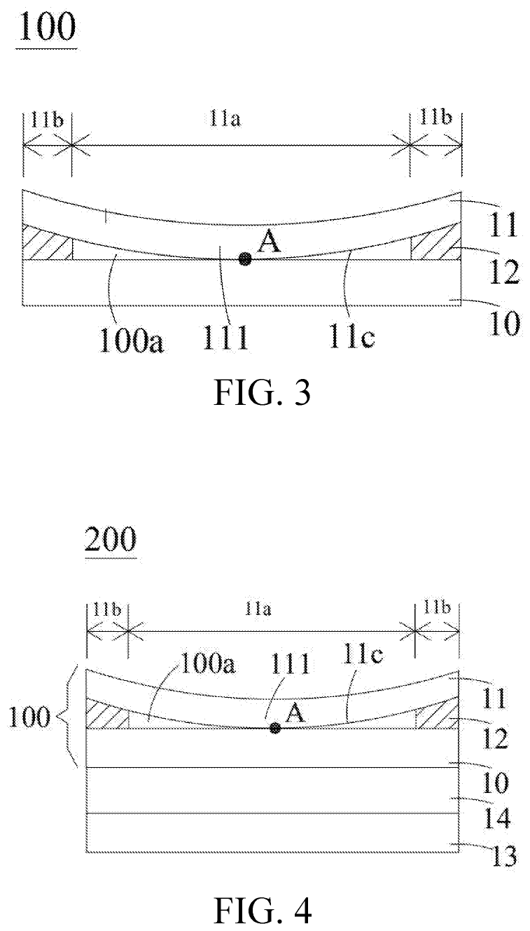

Please refer to FIG. 3, which is a schematic diagram of a touch screen of a third embodiment of the present disclosure. The touch screen shown in FIG. 3 is basically similar to the touch screen shown in FIG. 2, and a difference is that a thickness of a sealant 12 gradually increases from a concave region 11a toward a direction away from the concave region 11a. Thus, a connection region 11b of a cover 11 is bent under an action of an adhesive force so that a recess portion 111 occupies more space of a chamber 100a such that the space of a chamber 100a is reduced, a hollow feeling is decreased, and an instability of the space occupied by the chamber 100a is decreased.

Please refer to FIG. 4, which is a schematic diagram of a touch display device of the first embodiment of the present disclosure. The touch display device 200 includes the touch screen 100, a display panel 13, and an adhesive layer 14.

The touch screen 100 includes the touch panel 10, the cover 11, and the sealant 12. The cover 11 includes the concave region 11a and the connection region 11b surrounding the concave region 11a. The sealant 12 is disposed in the connection region 11b and is configured to connect the cover 11 with the touch panel 10. The sealant 12, the touch panel 10, and the cover 11 form the chamber 100a. The concave region 11a of the cover 11 is recessed into the chamber 100a to form the recess portion 111. The recess portion 111 occupies a partial space of the chamber 100a, which reduces the space of the chamber 100a, thereby improving a hollow feeling and reducing spatial instability of the chamber 100a. The recess portion 111 includes the concave surface 11c near the touch panel 10. The vertical distance from the top A of the concave surface 11c near the touch panel 10 to the touch panel 10 is greater than or equal to zero.

Furthermore, the chamber 100a is a vacuum chamber. With the sealant 12, a sealing of the touch screen 100 is further improved, and moisture and dust are prevented from entering the chamber 100a, so that the cover 11 of the concave region 11a is closer to the touch panel 10. The chamber 100a takes up less space, thereby improving the hollow feeling and reducing the spatial instability of the chamber 100a.

The thickness of the sealant 12 gradually increases from the concave region 11a toward a direction away from the concave region 11a. Thus, the connection region 11b of the cover 11 is bent under an action of an adhesive force so that the recess portion 111 occupies more space of the chamber 100a such that the space of a chamber 100a is reduced, the hollow feeling is decreased, and the instability of the space occupied by the chamber 100a is decreased. Material of the sealant 12 includes a hot melt adhesive.

The touch screen 100 is connected to the display panel 13 via the adhesive layer 14. The adhesive layer 14 is disposed between the touch screen 100 and the display panel 13. The display panel 13 can be a liquid crystal display panel or an organic light emitting diode display panel. The adhesive layer 14 is formed by a full-surface adhering method, that is, an entire surface of the adhesive layer 14 is formed on a surface of the display panel 13 facing the touch screen 100.

In the touch display device of the embodiment of the present disclosure, since the concave region of the cover is recessed into the chamber to form the recess portion, the space occupied by the chamber is reduced, thereby reducing the hollow feeling caused by the chamber and reducing the spatial instability of the chamber. In addition, the sealant prevents moisture, dust, and the like from entering the chamber.

It should be noted that the above embodiments are merely provided for describing the technical solutions of the present disclosure. It should be understood by persons of ordinary skill in the art that although the present disclosure has been described in detail with reference to the embodiments, modifications can be made to the technical solutions described in the embodiments, or equivalent replacements can be made to some technical features in the technical solutions, as long as such modifications or replacements do not cause the essence of corresponding technical solutions to depart from the spirit and scope of the present disclosure.

What is claimed is:

1. A touch screen, comprising a touch panel, a cover, and a sealant, wherein the cover comprises a concave region and a connection region surrounding the concave region, the sealant is disposed in the connection region and is configured to connect the cover with the touch panel, and the sealant, the touch panel, and the cover form a chamber; and
wherein the concave region of the cover is recessed into the chamber to form a recess portion, the chamber is a vacuum chamber, and a thickness of the sealant gradually increases from the concave region toward a direction away from the concave region.

2. The touch screen as claimed in claim 1, wherein the recess portion comprises a concave surface near the touch panel.

3. The touch screen as claimed in claim 2, wherein a vertical distance from a top of the concave surface near the touch panel to the touch panel is greater than or equal to zero.

4. The touch screen as claimed in claim 1, wherein material of the sealant comprises a hot melt adhesive.

5. A touch screen, comprising a touch panel, a cover, and a sealant, wherein the cover comprises a concave region and a connection region surrounding the concave region, the sealant is disposed in the connection region and is configured to connect the cover with the touch panel, the sealant, the touch panel, and the cover form a chamber, and the concave region of the cover is recessed into the chamber to form a recess portion.

6. The touch screen as claimed in claim 5, wherein the recess portion comprises a concave surface near the touch panel.

7. The touch screen as claimed in claim 6, wherein a vertical distance from a top of the concave surface near the touch panel to the touch panel is greater than or equal to zero.

8. The touch screen as claimed in claim 5, wherein the chamber is a vacuum chamber.

9. The touch screen as claimed in claim 5, wherein a thickness of the sealant gradually increases from the concave region toward a direction away from the concave region.

10. The touch screen as claimed in claim 5, wherein material of the sealant comprises a hot melt adhesive.

11. A touch display device, comprising a touch screen, wherein the touch screen comprises a touch panel, a cover, and a sealant; and
wherein the cover comprises a concave region and a connection region surrounding the concave region, the sealant is disposed in the connection region and is configured to connect the cover with the touch panel, the sealant, the touch panel, and the cover form a chamber, and the concave region of the cover is recessed into the chamber to form a recess portion.

12. The touch display device as claimed in claim 11, wherein the recess portion comprises a concave surface near the touch panel.

13. The touch display device as claimed in claim 12, wherein a vertical distance from a top of the concave surface near the touch panel to the touch panel is greater than or equal to zero.

14. The touch display device as claimed in claim 11, wherein the chamber is a vacuum chamber.

15. The touch display device as claimed in claim 11, wherein a thickness of the sealant gradually increases from the concave region toward a direction away from the concave region.

16. The touch display device as claimed in claim 11, wherein material of the sealant comprises a hot melt adhesive.
